(19) United States
(12) Patent Application Publication
(10) Pub. No.: US 2011/0307541 A1
(43) Pub. Date: Dec. 15, 2011

(54) SERVER LOAD BALANCING AND DRAINING IN ENHANCED COMMUNICATION SYSTEMS

(75) Inventors: Conal Walsh, Vancouver (CA); Vadim Eydelman, Bellevue, WA (US); Dhigha Sekaran, Redmond, WA (US); Amey Parandekar, Kirkland, WA (US)

(73) Assignee: MICROSOFT CORPORATION, Redmond, WA (US)

(21) Appl. No.: 12/797,857

(22) Filed: Jun. 10, 2010

(51) Int. Cl. G06F 15/16; G06F 15/173

(52) U.S. Cl. 709/203; 709/226; 709/227; 709/245; 709/230

(57) ABSTRACT

Resilient load balancing servers in an enhanced communication system is provided mitigating server failures or scheduled shutdowns. A repeatable but virtually random sequence of servers is generated for a given pool of homogeneous servers based on a user identifier in a request message. If a request cannot be routed to a first choice server, for any reason, then subsequent servers in the sequence are selected. A communication protocol within the system is adapted to permit an individual server to indicate that it cannot accept new requests. Following the indication from the server, traffic associated with existing dialogs is allowed to continue to be processed by the server, but new dialogs are directed to other servers.

### BACKGROUND

As an alternative to Public Switched Telephone Network (PSTN) systems, cellular phone networks have proliferated over the last decades, where users with cellular phones have access to one or more networks at almost any location. Also a recent development is the wide spread use of Voice over IP (VOIP) telephony, which uses internet protocol (IP) over wired and wireless networks. With the availability of such diverse types of communication networks and devices capable of taking advantage of various features of these networks, enhanced communication systems bring different communication networks together providing until now unavailable functionality such as combining various modes of communication (e.g. instant messaging, voice calls, video communications, etc.). This technology is also referred to as unified communications (UC). A network of servers manages end devices capable of handling a wide range of functionality and communication while facilitating communications between the more modern unified communication network devices and other networks (e.g. PSTN, cellular, etc.).

Enhanced communication systems providing multi-modal communications operate in a similar fashion to (sometimes the same) data exchange networks where designated servers and their backups provide services (e.g. routing of calls). Session Initiation Protocol (SIP) is a commonly used communication protocol between components of such systems. Load balancing SIP traffic across a pool of homogenous servers is a typical mechanism to achieve system scalability. There are two common categories of load balancing: a hardware device that sits in front of the pool and acts as a single entity; and software algorithms such as publishing multiple Domain Name Server Address (DNSA) records for the pool Fully Qualified Domain Name (FQDN). Neither approach offers a means of gracefully shutting down a given server, permitting existing sessions to close in proper order so as to not affect user quality of experience. Furthermore, neither solution inherently achieves repeatable routing of SIP messages, so as to optimize cached information on a server.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to load balancing servers in an enhanced communication system while mitigating failures. A repeatable but virtually random sequence of servers may be generated for a given pool of homogeneous servers based on a user identifier. If a request cannot be routed to a first choice server, for any reason, then the second choice server may be selected, and so on. According to some embodiments, the communication protocol may be modified to permit an individual server to indicate that it cannot accept new requests at this time. Following the indication from the server, traffic associated with existing dialogs may continue to be processed by the server, but new dialogs may be directed to other servers.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a diagram illustrating an example enhanced communications system such as a UC system, where embodiments may be implemented for providing resilient load balancing;

FIG. 2 illustrates an example on premise DNS load balancing in an enhanced communication system architecture according to embodiments;

FIG. 3 illustrates an example service DNS load balancing topology in an enhanced communication system architecture according to embodiments;

FIG. 4 is a conceptual diagram illustrating example implementations of server sequencing and use of “draining” mode for resilient load balancing;

FIG. 5 is a block diagram of an example computing operating environment, where embodiments may be implemented; and

FIG. 6 illustrates a logic flow diagram for a process of providing resilient load balancing in an enhanced communication system according to embodiments.

### DETAILED DESCRIPTION

As briefly described above, repeatable but virtually random sequence of servers may be generated for a given pool of homogeneous servers based on a user identifier associated with a request message for directing requests in case of server failures within the pool. The communication protocol may also be modified to permit an individual server to indicate that it cannot accept new requests due to scheduled or expected shutdown. Following the indication from the server, traffic associated with existing dialogs may continue to be processed by the server, but new dialogs may be directed to other servers. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable media.

Throughout this specification, the term “platform” may be a combination of software and hardware components for managing multimodal communication systems or redundancy systems. Examples of platforms include, but are not limited to, a hosted service executed over a plurality of servers, an application executed on a single server, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below. The term “site” as used herein refers to a geographical location and may include data centers, branch offices, and similar communication sub-systems. The term “call” refers to multi-modal communication sessions, examples of which are discussed below. Thus, a “call” is not limited to audio communications. Furthermore, the term cluster refers to a group of physical and/or virtual servers, which may provide the same service to a client in a transparent manner (i.e., the client sees a single server, while the cluster may have a plurality of servers).

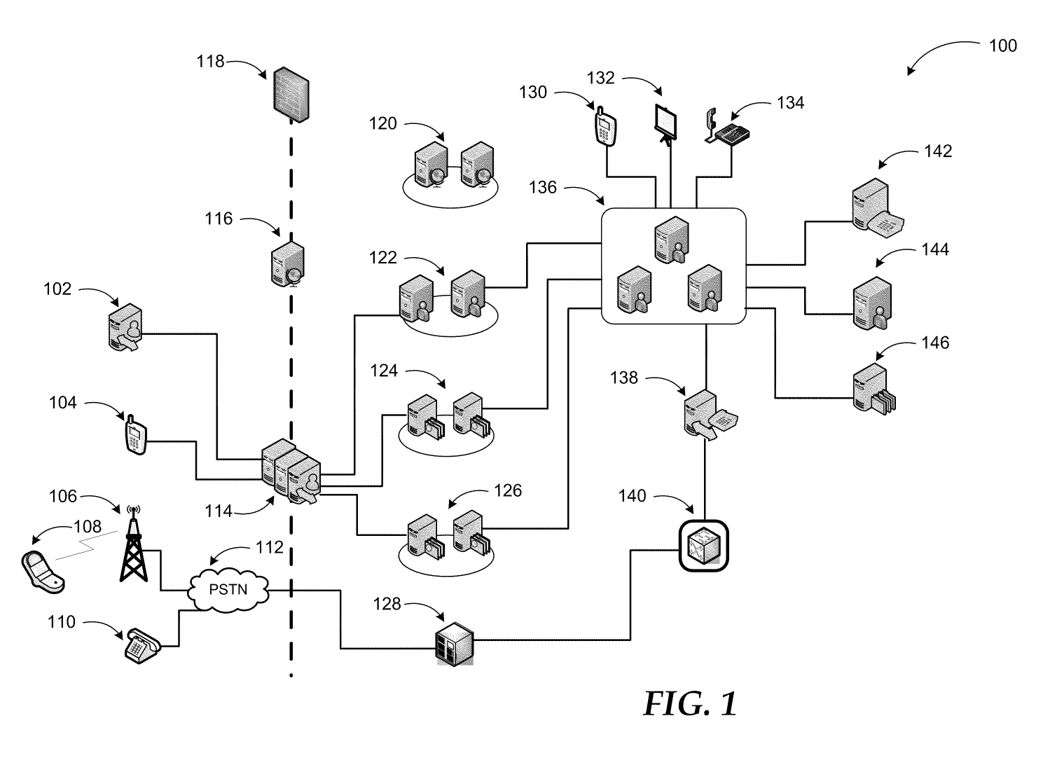

FIG. 1 includes diagram 100 illustrating an example enhanced communications system such as a UC system, where embodiments may be implemented for providing resilient load balancing. A unified communication (UC) system is an example of modern communication systems with a wide range of capabilities and services that can be provided to subscribers. A unified communication system is a real-time communications system facilitating email exchange, instant messaging, presence, audio-video conferencing, web conferencing, and similar functionalities.

In a unified communication (UC) system such as the one shown in diagram 100, users may communicate via a variety of end devices 130, 132, 134, which are client devices of the UC system. Each client device may be capable of executing one or more communication applications for voice communication, video communication, instant messaging, application sharing, data sharing, and the like. In addition to their advanced functionality, the end devices may also facilitate traditional phone calls through an external connection such as through Private Branch Exchange (PBX) 128 to a Public Switched Telephone Network (PSTN) 112. Further communications through PSTN 112 may be established with a telephone 110 or cellular phone 108 via cellular network tower 106. End devices 130, 132, 134 may include any type of smart phone, cellular phone, any computing device executing a communication application, a smart automobile console, and advanced phone devices with additional functionality.

The UC system shown in diagram 100 may include a number of servers performing different tasks. For example, edge servers 114 may reside in a perimeter network and enables connectivity through UC network(s) with other users such as remote user 104 or federated server 102 (for providing connection to remote sites). A Hypertext Transfer Protocol (HTTP) reverse protocol proxy server 116 may also reside along the firewall 118 of the system. Edge servers 114 may be specialized for functionalities such as access, web conferencing, audio/video communications, and so on. Inside the firewall 118, a number of clusters for distinct functionalities may reside. The clusters may include web servers for communication services 120, directory servers 122, web conferencing servers 124, and audio/video conferencing and/or application sharing servers 126. Depending on provided communication modalities and functionalities, fewer or additional clusters may also be included in the system.

The clusters of specialized servers may communicate with a pool of registrar and user services servers 136. The pool of registrar and user services servers 136 is also referred to as a data center. A UC system may have one or more data centers, each of which may be at a different site. Registrar servers in the pool register end points 130, 132, and 134, and facilitate their communications through the system acting as home servers of the end points. User services server(s) may provide presence, backup monitoring, and comparable management functionalities. Pool 136 may include a cluster of registrar servers. The registrar servers may act as backups to each other. The cluster of registrar servers may also have backup clusters in other data servers as described later.

Mediation server 138 mediates signaling and media to and from other types of networks such as a PSTN or a cellular network (e.g. calls through PBX 128) together with IP-PSTN gateway 140. Mediation server 138 may also act as a Session Initiation Protocol (SIP) user agent. In a UC system, users may have one or more identities, which is not necessarily limited to a phone number. The identity may take any form depending on the integrated networks, such as a telephone number, a Session Initiation Protocol (SIP) Uniform Resource Identifier (URI), or any other identifier. While any protocol may be used in a UC system, SIP is a commonly used method. SIP is an application-layer control (signaling) protocol for creating, modifying, and terminating sessions with one or more participants. It can be used to create two-party, multiparty, or multicast sessions that include Internet telephone calls, multimedia distribution, and multimedia conferences. SIP is designed to be independent of the underlying transport layer.

Additional components of the UC system may include messaging server 142 for processing voicemails and similar messages, application server 144 for specific applications, and archiving server 146. Each of these may communicate with the data center pool of registrar and user services servers 136. Various components of the system may communicate using protocols like SIP, HTTP, and comparable ones.

In a UC system with a large number of servers and specialized devices, optimized distribution of traffic (load balancing) is one of the design considerations. Requests for services from clients and other servers may be distributed across a pool of servers by publishing multiple DNSA records (IP addresses) for a single pool FQDN, otherwise known as “DNS round robin” routing. Typical implementations may route a SIP message by selecting an IP address from those published in incremental fashion or employing a pseudo-random process. A SIP client that connects to a home server pool may send a series of SIP register requests as it determines what information it needs to provide in order to authenticate. However, a server may be entirely unavailable, such that no connection to it can be established; information to authenticate the client may need to be recovered from a back-end database, such as a directory server; and a server may be scheduled to be shut down for software update or maintenance and may not be able to accept new requests at that particular time.

In traditional DNS round robin systems, if a client fails to connect to one of the servers in the pool, it simply fails. There is no failover to a different IP address. In a DNS based load balancing implementation according to embodiment, the client fails over by trying to connect to a second server, then a third server, and so on. A traditional DNS system may also be unaware of the second consideration: in the usual case where all servers in the pool are available, DNS round robin does not ensure that each SIP request from the client is routed to the same authenticating server and so does not take advantage of cached authentication information in the server that handled the initial request. Moreover, DNS round robin fails to address the third consideration: if a server rejects the client's request because it cannot process it, such that the client sends a second request to retry, the second request may be directed to the same server. This conflict may be exacerbated when there are multiple hops (proxies) in the routing path.

To enable a client to always be able to connect to one of the servers in the pool (as long as one server in the pool is available) without a hardware load balancer for the SIP ports, a sequence of servers for the given pool may be returned by DNS. The sequence of servers for a given pool may be generated by an algorithm. If a request cannot be routed to the first choice server, for any reason, the second server in the sequence may be selected, and so on. The input to the algorithm may be derived from the “From” field of user URI of the message, which does not change between SIP requests from a given client. If the algorithm is implemented universally across the system, routing of requests from a given client may also be repeatable across multiple proxy servers, such as when there is an edge server in the routing path. Load balancing may still be achieved when there are many clients because the output from the algorithm is repeatable but virtually random for a given user URI.

Servers not being able to accept new requests due to scheduled shutdown or maintenance may be addressed by implementing an extension to the SIP protocol that permits an individual server to indicate that it cannot accept new requests at this time. When a server is in this “draining” mode, traffic associated with existing SIP dialogs may continue to be processed by the server, but no new dialogs may be allowed to be established. The draining mode behavior may be applied to different types of SIP dialogs such as REGISTER, INVITE, and comparable ones. More detailed examples are discussed below.

While the example system in FIG. 1 has been described with specific components such as registrar servers, mediation servers, A/V servers, and similar devices, embodiments are not limited to these components or system configurations and can be implemented with other system configuration employing fewer or additional components. Functionality of enhanced communication systems with a resilient load balancing architecture may also be distributed among the components of the systems differently depending on component capabilities and system configurations. Furthermore, embodiments are not limited to unified communication systems. The approaches discussed here may be applied to any data exchange in a networked communication environment using the principles described herein.

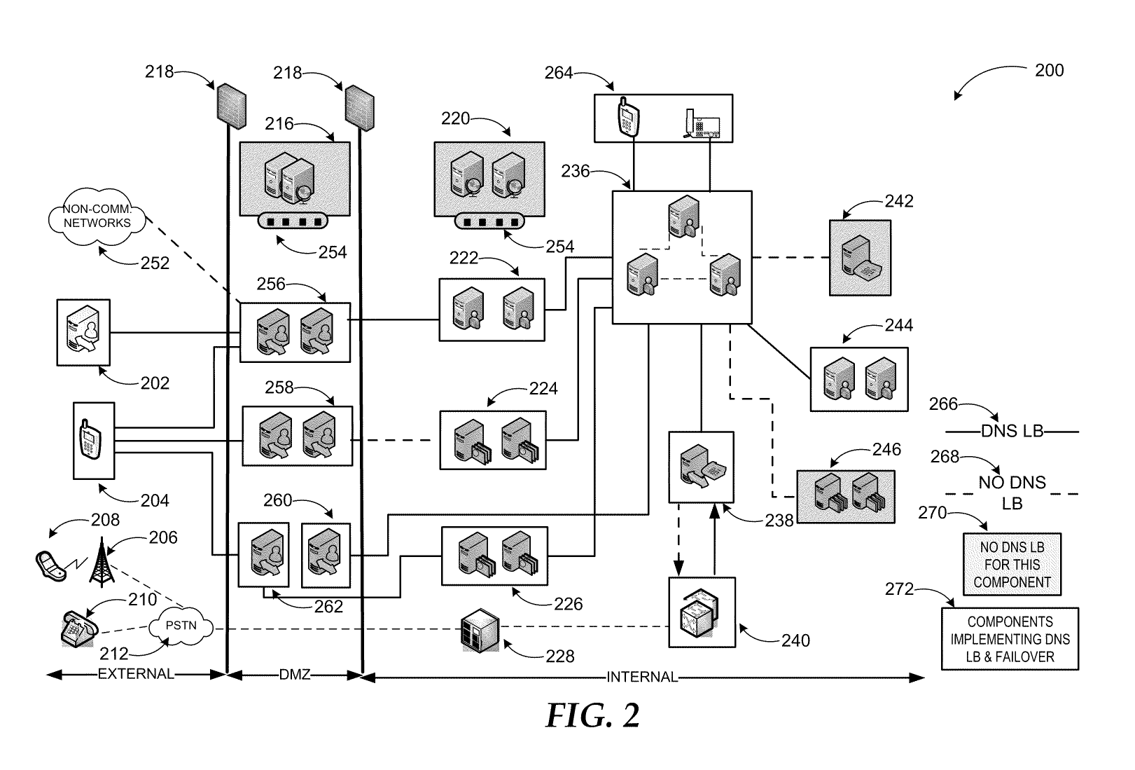

FIG. 2 illustrates diagram 200 of an example on premise DNS load balancing in an enhanced communication system architecture according to embodiments. As shown in diagram 200, external connections to the communication system may be established through conventional communications devices such as telephone 210 or cellular phone 208 via cellular network 206 and PSTN 212, as discussed previously. Users can also access the network (i.e. data center 236) through a client device/application 204 remotely by going through one or more of access edge servers 256, web conferencing edge servers 258, or audio/video edge servers 262. Access edge servers 256 may communicate with data center 236 via a director cluster 222 using SIP. Web conferencing edge servers 258 may communicate with web conferencing servers 224 using persistent shared object model (PSOM) or similar protocol. Web conferencing servers 224, in turn, may use HTTP to communicate with data center 236. Audio/video edge servers 262 may exchange media with audio/video conferencing and application sharing servers 226, which may also use HTTP to communicate with data center 236. Multi-Record Application (MRA) server(s) 260 may reside in the “demilitarized” (DMZ) zone defined by firewalls 218 along with the other edge servers and communicate with the data center 236 directly via SIP.

Federated servers 202 of other communication service branches may also access the system through access edge servers 256 employing SIP. Furthermore, “non-communication” networks 252 such as social networking networks, search services, etc. may be accessed by clients of the enhanced communication system through access edge servers 256 using SIP. HTTP reverse proxy servers 216 may also reside in the DMZ along with integrated or associated hardware load balancer(s) 254.

On the “internal” side of the system, web services cluster 220 may provide web services with its associated HLB 254. Internal clients 264 (devices, applications) facilitating multi-modal communications for subscribers of the system may communicate with the data center 236 via SIP. External PSTN communications may be directed through an internal PBX 228 and IP-PSTN gateways 240 to mediation server 238. The gateways may use a protocol other than SIP to communicate with mediation server 238, which may use SIP to communicate with data center 236. Exchange messaging server 242 may manage voicemails for subscribers of the system communicating with the data center using SIP. Similarly, application servers 244 may provide various applications communicating with the data center directly via SIP. Archiving and monitoring servers 246 may communicate with data center 236 via multi-server multi-queue (MSMQ) protocol or similar one.

Of the components of enhanced communication system in diagram 200, some may not be eligible for DNS load balancing (270), while a majority may implement DNS load balancing with failover (272). The components without DNS load balancing include HTTP reverse proxy servers 216, web services cluster 220, and archiving and monitoring servers 246. Connections subject to load balancing with failover are illustrated in the diagram as straight lines (266), while those not subject to DNS load balancing are shown with dashed lines (268).

DNS based load balancing according to embodiments may be implemented at the application level. The application (a client, a SIP server, or a hardware load balancer) may try to connect to a server in a cluster by connecting to one of the IP addresses resulting from the DNSA query for the cluster FQDN. If the connection attempt fails, the application may attempt to connect to the next IP address in the generated sequence thereby facilitating failover. DNS based load balancing is different from conventional DNS round robin (DNS RR), which typically refers to load balancing by relying on DNS to provide one or more IP address corresponding to one of the servers in a cluster—with a different order of IP addresses being returned every time a DNSA query is resolved by the DNS Server. Typically, DNS RR may enable load balancing, but does not enable failover. If the connection to the one IP address returned by the DNSA query fails, the connection fails. Hence it is less reliable than DNS based load balancing.

DNS based load balancing may also help to reduce administration cost associated with configuring hardware load balancers (HLBs). Although HLBs may still be used for HTTP traffic, configuring HLBs may be a challenging task. The server draining mode enabled by some embodiments provides administrators with the ability to put a (physical) server into maintenance mode, such that no new connections (or dialogs) are accepted and existing connections (or dialogs) continue until they naturally expire. This may minimize service disruption ahead of a planned outage.

When SIP servers (e.g. access edge servers) are load balanced using an HLB, the HLB maintains a list of SIP servers that are active by periodically attempting Transmission Control Protocol (TCP) connections to the listening ports on these servers. When a client or peer server connects via TCP to the HLB, the HLB may direct the connection to one of the active SIP servers. According to some embodiments, an access edge server may be marked for draining by shutting down the listening port, so that it does not accept further connections. However, this approach may not work in some cases such as mediation servers because it is not possible to shut down the listening port in order to drain these applications. Mediation servers and similar applications maintain state and shutting down a listening port may result in peer servers or clients not being able to connect to such a server at all. A conventional HLB may continue to send traffic to an application that is being drained. DNS load balancing according to embodiments may enable a server to transmit an “enable-dns-failover” message when being drained and then the front end server may route new dialogs to another application/server.

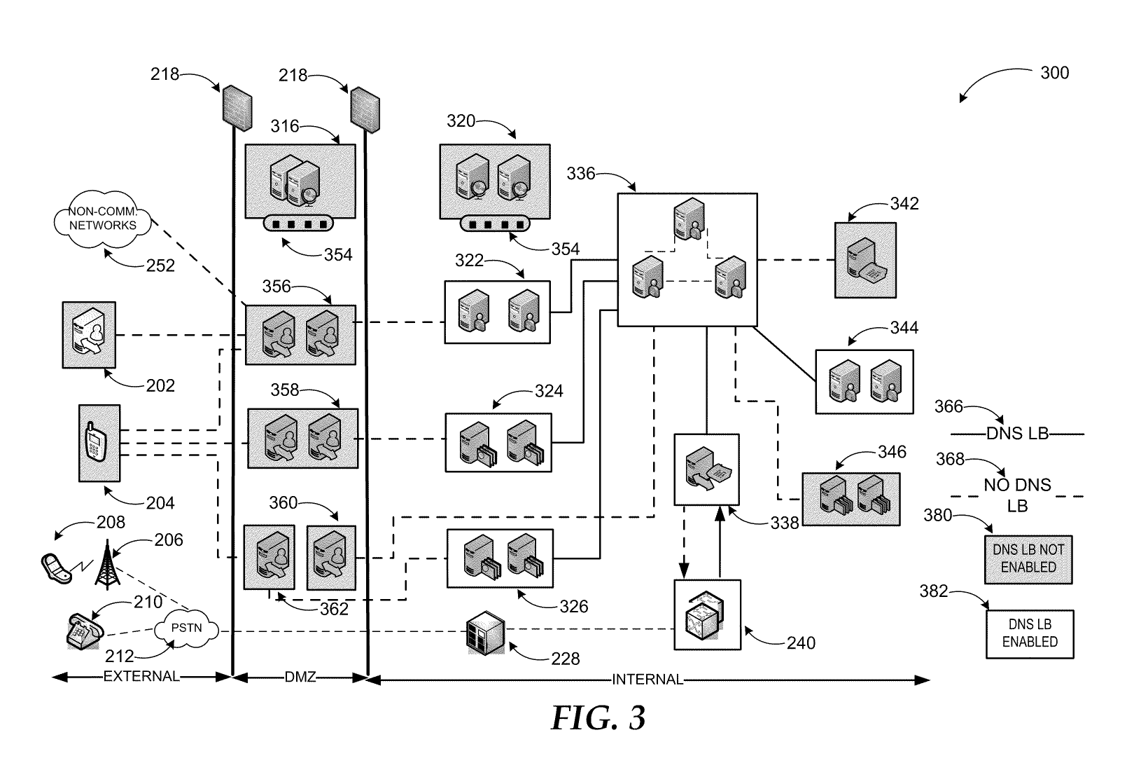

FIG. 3 illustrates diagram 300 of an example service DNS load balancing topology in an enhanced communication system architecture according to embodiments. Components numbered similarly to those in diagram 200 of FIG. 2 in diagram 300 may perform similar or same tasks and be structured in a likewise manner.

In an example system employing SIP according to some embodiments, a server may indicate that it is in draining mode by sending a SIP 503 failure response to a request asking to establish a new SIP dialog. Since there may be a variety of reasons for sending a 503 response, the 503 response may include a modified SIP header “enable-dns failover” if failover to another server is desirable. The header may indicate to the local server (e.g. edge server) that it should attempt to send the SIP request to the next server indicated by the DNS load balancing algorithm. The header content may be a single token “yes” or “no”. If the header is present with value “yes” then failover to the next choice server may be executed, otherwise it may be suppressed.

Embodiments may also be implemented in conjunction with caching of failed connection attempts in the client or previous hop server. Each client or server may retain state information about failed routing attempts in order to avoid frequent retries to an unresponsive or draining server. When a routing attempt fails to one or several, but not all, servers in the pool, the unresponsive or draining server(s) may be marked as inactive and a predefined retry interval set (e.g. 10 minutes). After the retry interval, routing to each server may resume, and they may be marked as available again if they respond and are no longer draining. If all servers in the pool are marked as down or draining, then attempts to route messages to each server may commence in the order indicated by the load balancing algorithm. It may be expected that a given server first enters draining mode, is later shut down and refuses connection attempts, and is eventually brought back up again after maintenance is completed.

A system according to embodiments may provide a number of services including instant messaging, presence, conferencing, including PSTN conferencing. This may necessitate deployment of mediation servers 338, application servers 344, and the like. The services topology may also include HLBs 354 for clients interacting with servers including front end servers (e.g. edge servers 356, 358, 362), web conferencing edge servers 324 and media relay applications. This enables the system to handle availability of a large number of public IP addresses and IP throughput issues that may result from exposing large number of public IP addresses.

In service DNS load balancing topology diagram 300, some of the components may be DNS load balancing enabled (380), while others may not be DNS load balancing enabled (382). The components without DNS load balancing may include external client device/application 204, federated servers 202 of other communication system branches, any of the servers in the DMZ (e.g. 316, 356, 358, 360, 362), HLBs 354, web services cluster 320, exchange messaging server 342, and archiving and monitoring servers 346. In this example configuration, DNS based load balancing with failover is limited to clusters communicating with data center 336 directly via SIP such as director cluster 322, web conferencing servers 324, audio/video conferencing and application sharing servers 326, mediation server 338, and application servers 344. As in diagram 200, connections subject to load balancing with failover are illustrated in the diagram as straight lines (366), while those not subject to DNS load balancing are shown with dashed lines (368).

To implement DNS based load balancing, appropriate DNSA records may be configured for the servers. Once a server is added to a cluster, the DNSA record for the server may also be added to the cluster FQDN. For example, if a registrar cluster FQDN is rc1.contoso.com and the cluster has two servers, R1 and R2, DNS configuration may be as follows:

Zone=Contoso.com

DNSA Records

FQDN IP

R1.contoso.com 192.168.1.3

R2.contoso.com 192.168.1.4

RC1.contoso.com 192.168.1.3

RC1.contoso.com 192.168.1.4

If server R3 is to be added to the cluster, the following DNSA records may be added:

R3.contoso.com 192.168.1.5

RC1.contoso.com 192.168.1.5

It may take up to DNS time-to-live (TTL) time for other SIP servers or clients to start connecting to this newly added SIP server. The DNS cache may issue DNS queries after DNS TTL expires or if the cache is emptied through an IP configuration “ipconfig” or DNS flush “flushdns”. In addition, front end servers, access edge server, or director servers may maintain an internal DNSA record cache. In order to enable peer servers and clients to discover the added or deleted SIP server, DNS TTL may be configured sufficiently low (e.g. 30 min). Alternatively, the DNS cache may be programmatically flushed on all peer SIP servers. After a server is removed from the cluster and the corresponding DNSA record deleted from DNS, other peer servers and clients may still try to connect to that IP address up to the DNS TTL time. Still, the other SIP servers and clients implementing DNS based load balancing and failover, they may be able to connect to another server in the cluster.

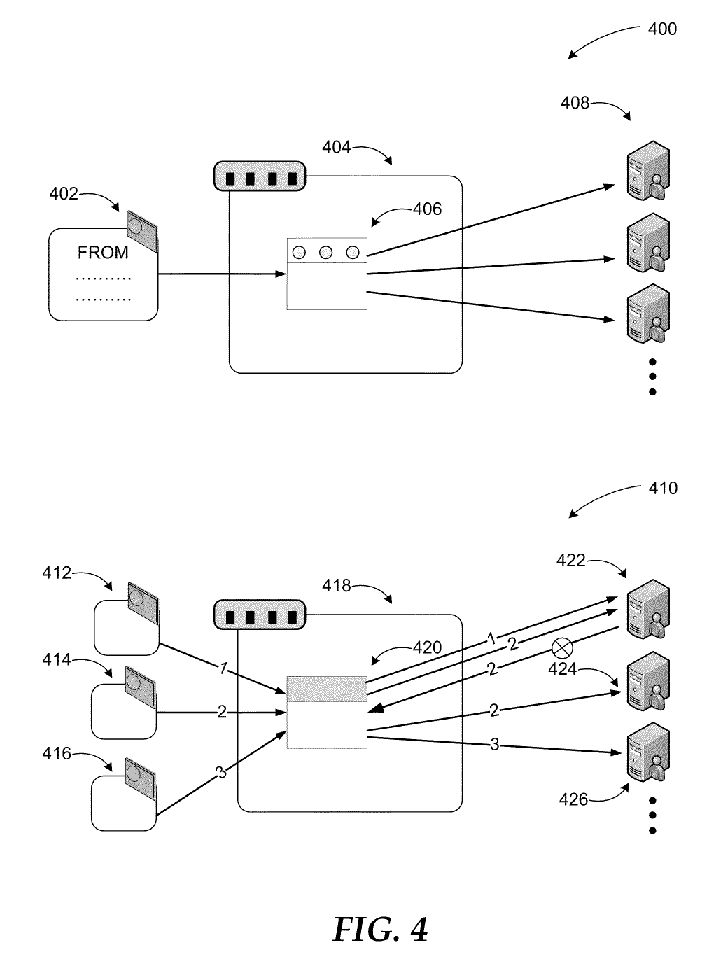

FIG. 4 is a conceptual diagram illustrating example implementations of server sequencing and use of “draining” mode for resilient load balancing.

Diagram 400 illustrates how a sequencing module 406 of a DNS based load balancing server (or client) 404 may receive a request 402 from a user and generate a sequence of servers to be tried based on a “From” field of user URI of the request 402, which does not change between SIP requests from a given client. The request may then be routed to servers 408 following the order of the sequence, which is repeatable but virtually random because the same sequencing algorithm may be implemented universally across the system. Thus, load balancing may still be achieved when there are many clients because the output from the algorithm is dependent on a given user URI

Diagram 410 illustrates an example draining mode scenario. As shown in diagram 410, individual clients 412, 414, and 416 may submit their requests to load balancing capable server 418 in the order shown in the figure. Routing module 420 of the server may submit the first request to server 422. While the first request is being processed by server 422, the server may transition into draining mode due to scheduled shutdown or maintenance. Thus, when the routing module 420 attempts to send the second request to server 422, it may receive a message from server 422 indicating that it is not accepting new requests because of the draining mode. Consequently, routing module 420 may resubmit the second request to server 424, optionally marking server 422 as down. Server 422 may continue processing the first request, however, until that task is completed. Third task may be submitted to server 424 or server 426 depending on load levels.

The example systems in FIG. 1 through 4 have been described with specific components such as registrar servers, communication servers, directory servers, presence servers, and the like. Embodiments are not limited to communication systems according to these example configurations. Furthermore, specific protocols are described for communication between different components. Embodiments are also not limited to the example protocols discussed above. Resilient DNS based load balancing with failover architecture in an enhanced communication system according to embodiments may be implemented using protocols, components, and configurations other than those illustrated herein employing fewer or additional components and performing other tasks.

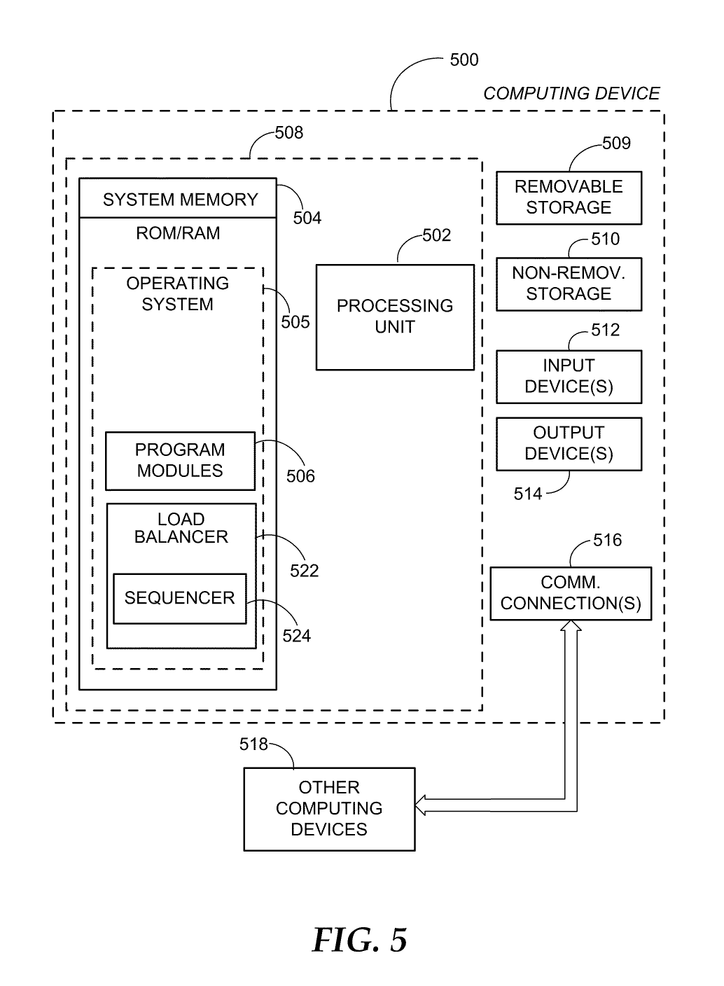

FIG. 5 and the associated discussion are intended to provide a brief, general description of a suitable computing environment in which embodiments may be implemented. With reference to FIG. 5, a block diagram of an example computing operating environment for an application according to embodiments is illustrated, such as computing device 500. In a basic configuration, computing device 500 may be a server within a multi-modal enhanced communication system and include at least one processing unit 502 and system memory 504. Computing device 500 may also include a plurality of processing units that cooperate in executing programs. Depending on the exact configuration and type of computing device, the system memory 504 may be volatile (such as RAM), non-volatile (such as ROM, flash memory, etc.) or some combination of the two. System memory 504 typically includes an operating system 505 suitable for controlling the operation of the platform, such as the WINDOWS® operating systems from MICROSOFT CORPORATION of Redmond, Wash. The system memory 504 may also include one or more software applications such as program modules 506, load balancing application 522, and sequence generation module 524.

Load balancing application 522 may provide DNS based load balancing to clients, servers, and other components of the enhanced communication system as discussed above. As part of the DNS based load balancing, a sequence generation module 524 may generate a repeatable but virtually random sequence of servers to be used in case of failure of one or more servers such that load balancing can be accomplished with failover. This basic configuration is illustrated in FIG. 5 by those components within dashed line 508.

Computing device 500 may have additional features or functionality. For example, the computing device 500 may also include additional data storage devices (removable and/or non-removable) such as, for example, magnetic disks, optical disks, or tape. Such additional storage is illustrated in FIG. 5 by removable storage 509 and non-removable storage 510. Computer readable storage media may include volatile and nonvolatile, removable and non-removable media implemented in any method or technology for storage of information, such as computer readable instructions, data structures, program modules, or other data. System memory 504, removable storage 509 and non-removable storage 510 are all examples of computer readable storage media. Computer readable storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and which can be accessed by computing device 500. Any such computer readable storage media may be part of computing device 500. Computing device 500 may also have input device(s) 512 such as keyboard, mouse, pen, voice input device, touch input device, and comparable input devices. Output device(s) 514 such as a display, speakers, printer, and other types of output devices may also be included. These devices are well known in the art and need not be discussed at length here.

Computing device 500 may also contain communication connections 516 that allow the device to communicate with other devices 518, such as over a wired or wireless network in a distributed computing environment, a satellite link, a cellular link, a short range network, and comparable mechanisms. Other devices 518 may include computer device(s) that execute communication applications, other directory or policy servers, and comparable devices. Communication connection(s) 516 is one example of communication media. Communication media can include therein computer readable instructions, data structures, program modules, or other data. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

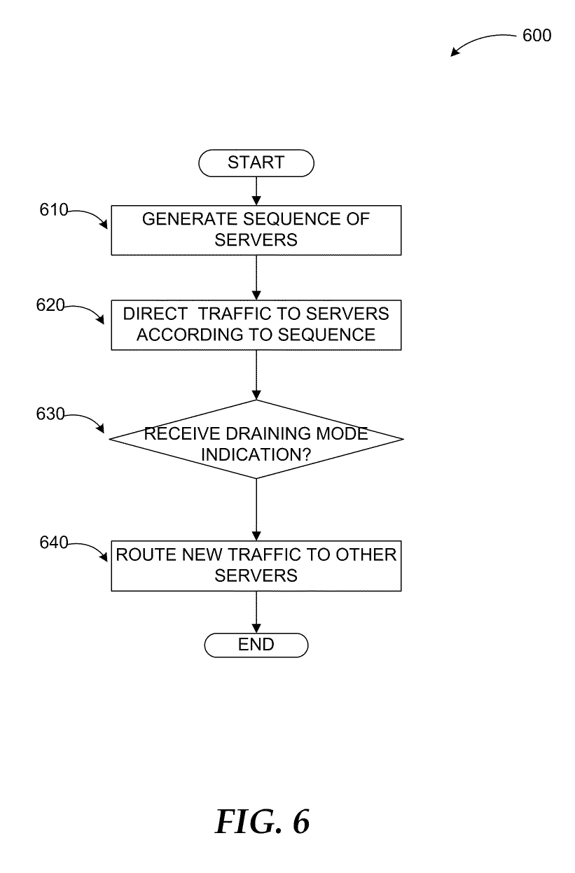

FIG. 6 illustrates a logic flow diagram for process 600 of providing resilient load balancing in an enhanced communication system according to embodiments. Process 600 may be implemented as part of an enhanced communication system.

Process 600 begins with operation 610, where a repeatable but virtually random sequence of servers is generated for load balancing with failover. IP addresses of the servers in the generated sequence resulting from a DNSA query for the cluster FQDN may be used to connect to a first server. If the connection attempt fails, the next IP address in the generated sequence may be tried at operation 620 thereby facilitating failover and load balancing at the same time.

If a server is expecting to be taken offline due to scheduled maintenance, upgrade, or similar reason, it may issue a message indicating it is in draining mode. Upon receiving the draining mode indication at operation 630, the routing server may direct new traffic to other server using the generated sequence at operation 640 while the server in draining mode continues to complete existing tasks before it is shut down.

The operations included in process 600 are for illustration purposes. Providing resilient DNS based load balancing with failover in an enhanced communication system according to embodiments may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to be executed at least in part in a computing device for providing resilient load balancing in an enhanced communication system, the method comprising:
receiving a request from a client at a load balancer;
generating a sequence of servers to receive the request based on an identifier of a user submitting the request;
attempting to route the request to a first server of the sequence; and
if the attempt fails, attempting to route the request to a subsequent server of the sequence.

2. The method of claim 1, wherein the load balancer is part of one of: a server and a Hardware Load Balancer (HLB).

3. The method of claim 2, wherein the server is one of: an edge server, a director server, an audio/video conferencing server, an application server, a mediation server, and a registrar server of the enhanced communication system.

4. The method of claim 1, further comprising:
in response to a failed connection attempt to a server in a server pool determined based on one of a plurality of Internet Protocol (IP) addresses resulting from a Domain Name Server Address (DNSA) query for the server pool Fully Qualified Domain Name (FQDN), enabling a client to connect to a next IP address in DNSA query results.

5. The method of claim 1, further comprising:
receiving a draining mode indication from a server at the load balancer;
submitting a subsequent request to a subsequent server of the sequence, wherein previously submitted requests at the server indicating draining mode are continued to be processed at that server.

6. The method of claim 5, wherein the draining mode specifies the server is in preparation for being taken offline for one of: a scheduled maintenance and a scheduled update.

7. The method of claim 5, wherein the draining mode indication includes a Session Initiation Protocol (SIP) 503 failure message.

8. The method of claim 7, wherein the SIP 503 message includes a modified “enable-dns-failover” header.

9. The method of claim 1, further comprising:
caching failed connection attempts in one of: a requesting client and a server performing the load balancing.

10. The method of claim 9, further comprising:
marking one of: an unresponsive server and a server in draining mode as inactive; and
attempting to route requests to the server marked as inactive after expiration of a predefined retry interval.

11. The method of claim 9, further comprising:
if an entire pool of servers is marked as inactive, attempting to route the requests following the sequence.

12. An enhanced communication system providing multi-modal communication services with resilient load balancing, the system comprising:
a plurality of function-specific servers communicating via Session Initiation Protocol (SIP);
one of the plurality of servers configured to execute a load balancing application, wherein the load balancing application is adapted to:
receive a request from a client;
generate a sequence of servers to receive the request based on an identifier of a user submitting the request;
attempt to route the request to a first server of the sequence;
if the attempt fails, attempt to route the request to a subsequent server of the sequence;
receive a draining mode indication from another one of the plurality of servers, the draining mode specifying the server is in preparation for being taken offline for one of: a scheduled maintenance and a scheduled update; and
submit a subsequent request to a subsequent server of the sequence, wherein previously submitted requests at the server indicating draining mode are continued to be processed at that server.

13. The system of claim 12, wherein each of the plurality of servers in a cluster are configured to:
upon addition of a new server to the cluster, adding a Domain Name Server Address (DNSA) record of the new server to a cluster Fully Qualified Domain Name (FQDN).

14. The system of claim 13, wherein the sequence includes a list if Internet Protocol (IP) addresses for the servers stored in a DNS cache executing the load balancing application, and the load balancing application is further configured to issue a DNS query following one of: expiration of a DNS time-to-live (TTL) and emptying of the DNS cache.

15. The system of claim 14, wherein at least one from a set of a front end server, an access edge server, and a director server is configured to maintain an internal DNS cache.

16. The system of claim 15, wherein the DNS cache of each server is configured to be programmatically flushed.

17. A computer-readable storage medium with instructions stored thereon for providing resilient load balancing in an enhanced communication system, the instructions comprising:
receiving a request from a client, wherein the request includes a Domain Name Server Address (DNSA) query for a cluster Fully Qualified Domain Name (FQDN);
in response to the request, generating a sequence of Internet Protocol (IP) addresses of servers to receive the request based on an identifier of a user submitting the request;
attempting to route the request to a first server of the sequence;
if the attempt fails, attempting to route the request to a subsequent server of the sequence;
receiving a draining mode indication from another one of the plurality of servers, the draining mode specifying the server is in preparation for being taken offline for one of: a scheduled maintenance and a scheduled update; and
submitting a subsequent request to a subsequent server of the sequence, wherein previously submitted requests at the server indicating draining mode are continued to be processed at that server.

18. The computer-readable medium of claim 17, wherein the sequence is generated by a sequencing algorithm universally implemented across load balancing servers employing Session Initiation Protocol (SIP) within the enhanced communication system.

19. The computer-readable medium of claim 17, wherein the enhanced communication system employs at least one Hardware Load Balancer (HLB) for servers employing Hypertext Transfer Protocol (HTTP) to communicate.

20. The computer-readable medium of claim 17, wherein the draining mode indication includes a modified “enable-dns-failover” header with a single token, and wherein a load balancing server is configured to failover to the subsequent server if a value of the token is “yes” and suppress the draining mode indication if the value of the token is “no”.
